(19) United States
(12) Patent Application Publication
(10) Pub. No.: US 2023/0239738 A1
(43) Pub. Date: Jul. 27, 2023

(54) DISTRIBUTION OF TRAFFIC BETWEEN A MACRO ACCESS NODE AND A MICRO ACCESS NODE IN A HETEROGENEOUS NETWORK

(71) Applicant: Telefonaktiebolaget LM Ericsson (publ), Stockholm (SE)

(72) Inventors: Junying LIU, LUND (SE); Gunther AUER, GÖTEBORG (SE)

(21) Appl. No.: 18/009,169

(22) PCT Filed: Jun. 16, 2020
(86) PCT No.: PCT/EP2020/066644

§ 371 Date: Dec. 8, 2022

(51) Int. Cl. H04W 28/086; H04W 52/34; H04W 52/42

(52) U.S. Cl. CPC H04W 28/0864; H04W 52/343; H04W 52/42

(57) ABSTRACT

A mechanism for distributing traffic between a macro access node and a micro access node in a heterogeneous network is described. The method, performed by a network node controller, comprises obtaining information of current traffic load in the heterogeneous network. The method further comprises distributing the traffic between the macro access node and the micro access node by adjusting cell shaping beams of the macro access node as a function of the current traffic load.

### TECHNICAL FIELD

Embodiments presented herein relate to a method, a network node controller, a computer program, and a computer program product for distributing traffic between a macro access node and a micro access node in a heterogeneous network.

### BACKGROUND

In communications networks, there may be a challenge to obtain good performance and capacity for a given communications protocol, its parameters and the physical environment in which the communications network is deployed.

For example, as traffic demand grows, one way to increase the capacity, with respect to the number of served users, is to densify the existing communications network by deployment of micro access nodes in addition to already existing macro access nodes. One purpose of this is to increase the capacity at high user demand and to cover regions not sufficiently covered by the macro access nodes. A communications network comprising a mixture of macro access nodes and micro access nodes is commonly referred to as a heterogeneous network.

One challenge with heterogenous networks is to ensure that the micro access nodes serve a sufficient fraction of the overall traffic demand. One challenge is thus to ensure that the micro access nodes can serve enough users. In heterogenous networks, the users (such as user equipment; UE) commonly camps on the cell served by the strongest received downlink (DL) signal. Commonly, the Equivalent Isotropic Radiated Power (EIRP) of the macro access node is much higher than the EIRP of the micro access nodes, as micro access nodes commonly have less transmitted power and smaller radio hardware compared to the macro access nodes. As a result thereof, a large portion of users will camp on the cell served by the macro access node.

In Long Term Evolution (LTE) based telecommunication system, a parameter termed Cell Range Extension (CRE) introduces a cell selection offset of micro access nodes, so to extend the cell range of the micro access nodes. With this mechanism, one negative effect is that the interference of cell edge users in the DL served by the micro access node is increased. Further, it could be challenging to set an appropriate CRE value that fits different network configurations and traffic loads.

In fifth generation (5G) New Radio (NR) based telecommunication systems the cell range depends on the measurement on the synchronization signal block (SSB) as transmitted by the access nodes. A cell selection offset such as the CRE used in LTE might be reused in 5G NR systems. But as noted above, it might be challenging to select a proper CRE value to fit all traffic loads and different network configurations.

Hence, there is still a need for mechanisms to distribute the overall traffic demand in a heterogeneous network.

### SUMMARY

An object of embodiments herein is to enable efficient distribution of the overall traffic demand between a macro access node and a micro access node in a heterogeneous network.

According to a first aspect there is presented a method for distributing traffic between a macro access node and a micro access node in a heterogeneous network. The method is performed by a network node controller. The method comprises obtaining information of current traffic load in the heterogeneous network. The method comprises distributing the traffic between the macro access node and the micro access node by adjusting cell shaping beams of the macro access node as a function of the current traffic load.

According to a second aspect there is presented a network node controller for distributing traffic between a macro access node and a micro access node in a heterogeneous network. The network node controller comprises processing circuitry. The processing circuitry is configured to cause the network node controller to obtain information of current traffic load in the heterogeneous network. The processing circuitry is configured to cause the network node controller to distribute the traffic between the macro access node and the micro access node by adjusting cell shaping beams of the macro access node as a function of the current traffic load.

According to a third aspect there is presented a network node controller for distributing traffic between a macro access node and a micro access node in a heterogeneous network. The network node controller comprises an obtain module configured to obtain information of current traffic load in the heterogeneous network. The network node controller comprises a distribute module configured to distribute the traffic between the macro access node and the micro access node by adjusting cell shaping beams of the macro access node as a function of the current traffic load.

According to a fourth aspect there is presented a computer program for distributing traffic between a macro access node and a micro access node in a heterogeneous network, the computer program comprising computer program code which, when run on a network node controller, causes the network node controller to perform a method according to the first aspect.

According to a fifth aspect there is presented a computer program product comprising a computer program according to the fourth aspect and a computer readable storage medium on which the computer program is stored. The computer readable storage medium could be a non-transitory computer readable storage medium.

Advantageously these aspects enable efficient distribution of the overall traffic demand in the heterogeneous network.

Advantageously these aspects enable robust extension of the overall capacity in a heterogeneous network.

Advantageously these aspects enable reduction in the interference experienced by the micro access node and the users, such as cell edge users, served by the micro access node.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIGS. 1, 3, and 4 are schematic diagrams illustrating a heterogeneous network according to embodiments;

FIG. 2 is a flowchart of methods according to embodiments;

FIG. 5 is a schematic diagram showing functional units of a network node controller according to an embodiment;

FIG. 6 is a schematic diagram showing functional modules of a network node controller according to an embodiment;

FIG. 7 shows one example of a computer program product comprising computer readable storage medium according to an embodiment;

FIG. 8 is a schematic diagram illustrating a telecommunication network connected via an intermediate network to a host computer in accordance with some embodiments; and

FIG. 9 is a schematic diagram illustrating host computer communicating via a radio base station with a terminal device over a partially wireless connection in accordance with some embodiments.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

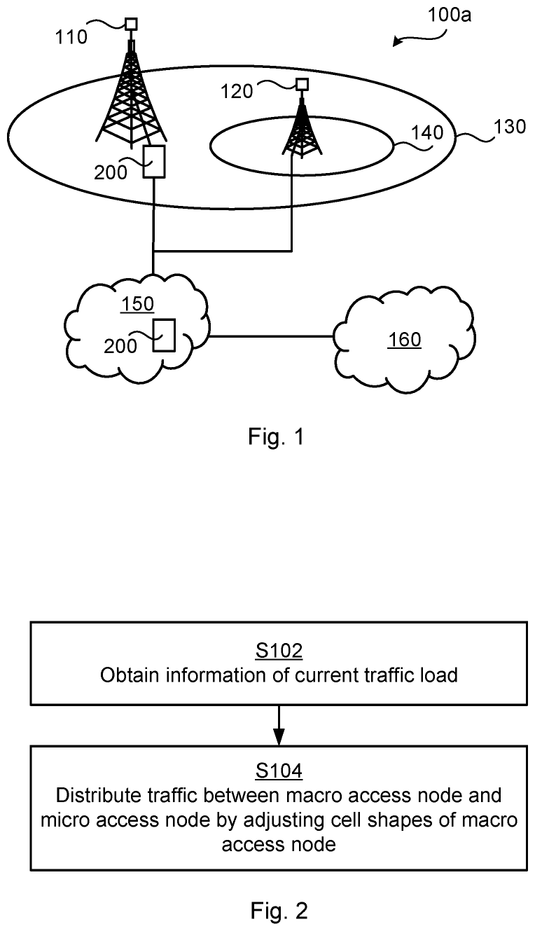

FIG. 1 is a schematic diagram illustrating a heterogeneous network 100a where embodiments presented herein can be applied. The heterogeneous network 100a comprises a macro access node 110 and a micro access node 120. Each of the macro access node 110 and the micro access node 120 could be any of: a radio access network node, a radio base station, a base transceiver station, a node B (NB), an evolved node B (eNB), a gNB, or an access point. As the skilled person, the heterogeneous network 100a might comprise a plurality of macro access nodes 110 and the micro access nodes 120; the herein disclosed embodiments are not limited to any particular number of macro access nodes 110 and micro access nodes 120 as long as there is at least one macro access node 110 and at least one micro access node 120 in the heterogeneous network 100a.

The macro access node 110 and the micro access node 120 are operatively connected to a core network 150 which in turn is operatively connected to a service data network 160 (such as the Internet). Operation of the macro access node 110 and the micro access node 120 is at least partly controlled by a network node controller 200. Further details of the network node controller 200 will be disclosed below.

The macro access node 110 is configured to provide service in a first serving region 130 and the micro access node 120 is configured to provide service in a second serving region 140. In some examples the second serving region 140 at least partly overlaps with the first serving region 130. In the illustrative example of FIG. 1, the second serving region 140 is a subregion of the first serving region 130. The macro access node 110 and the micro access node 120 are configured to provide network access, or service, to users. The users might be portable wireless devices, mobile stations, mobile phones, handsets, wireless local loop phones, user equipment (UE), smartphones, laptop computers, tablet computer, network-equipped sensor, network equipped vehicles, Internet of Things (IoT) devices, etc. Each user is commonly served by the access node 110, 120 for which the strongest signal level of some type of reference signal, such as SSB, is measured.

The macro access node 110 is configured for operation in a first frequency band and the micro access node 120 is configured for operation in a second frequency band. In some examples the first frequency band and the second frequency band at least partly overlap. In other examples, the second frequency range is a subrange of the first frequency range.

As noted above there is still a need for mechanisms to distribute the overall traffic demand in a heterogeneous network 100a.

In further detail, in some deployment scenarios, such as in urban environments, existing communications networks are densified to meet the growing traffic demands, such as for mobile broadband applications. Existing communications networks might be densified by deployment of more macro access nodes 110, and/or by deployment of micro access nodes 120, giving rise to heterogeneous networks 100a. In many cases, the added micro access nodes 120 are not deployed for coverage extension, but to enhance the network capacity. This means that the serving regions of individual cells might overlap, as in the illustrative example of FIG. 1. This might give rise to inter-cell interference between the macro access node 110 and the micro access node 120.

Whereas the macro access node 110 might be provided with an advanced antenna system such as an active antenna system (AAS), the micro access nodes 120 might, due to their limitations on size, weight, processing power, etc. not have an AAS as such or only have an AAS with a comparably low size. Likewise, the radiated power of the micro access nodes 120 is comparatively low in relation to the radiated power of the macro access nodes 110. Moreover, macro access nodes 110 are often installed vertically high up, such as above rooftop, which tends to extend the transmission range, due to more favorable transmission characteristics. This means that the serving region of macro access nodes 110 generally might be significantly larger than that of micro access nodes 120.

Due to the asymmetrical serving regions of the macro access nodes 110 and the micro access nodes 120, it could be challenging for the micro access nodes 120 to pick up a sufficient fraction of the overall traffic. Such scenarios could benefit from means to efficiently distribute traffic between the macro access nodes 110 and the micro access nodes 120.

The embodiments disclosed herein therefore relate to mechanisms for distributing traffic between a macro access node 110 and a micro access node 120 in a heterogeneous network 100a. In order to obtain such mechanisms there is provided a network node controller 200, a method performed by the network node controller 200, a computer program product comprising code, for example in the form of a computer program, that when run on a network node controller 200, causes the network node controller 200 to perform the method.

FIG. 2 is a flowchart illustrating embodiments of methods for distributing traffic between a macro access node 110 and a micro access node 120 in a heterogeneous network 100a. The methods are performed by the network node controller 200. The methods are advantageously provided as computer programs 720.

At least some of the herein disclosed embodiments are based on steering traffic between the access nodes 110, 120 of a heterogenous network 100a. The optimal share of traffic between macro access nodes 110 and micro access nodes 120 depends on several factors, such as power imbalance, difference in antenna systems, deployment densities, etc. One factor is the traffic load, which dynamically changes locally as well as at different times of the day. It is therefore assumed that cell shaping is dependent on the current traffic load in the heterogeneous network 100a. Hence, the network node controller 200 is configured to perform step S102:

S102: The network node controller 200 obtains information of current traffic load in the heterogeneous network 100a.

Beams that determine the cell shapes of the macro access node 110 are then adjusted dependent on the traffic load. Hence, the network node controller 200 is configured to perform step S104:

S104: The network node controller 200 distributes the traffic between the macro access node 110 and the micro access node 120 by adjusting cell shaping beams of the macro access node 110 as a function of the current traffic load.

In this respect, depending on implementation, the network node controller 200 might be configured to itself adjust the cell shaping beams of the macro access node 110 or be configured to instruct the macro access node 110 to itself adjust the cell shaping beams of the macro access node 110.

This enables users to be moved from the macro access node 110 to instead be served by the micro access node 120 at high traffic loads. This in turn allows to serve users with the best available serving access node at low traffic loads, which often is the macro access node 110, whilst enabling the macro access node 110 to be offloaded and the network capacity to be increased as traffic load increases.

Embodiments relating to further details of distributing traffic between a macro access node 110 and a micro access node 120 in a heterogeneous network 100a as performed by the network node controller 200 will now be disclosed.

In general terms, cell shaping beams are those beams in which reference signals are transmitted. The cell shaping beams constitute the serving region of a cell. The cell shaping beams are used to convey control channels, measurements, initial cell search, as well as reference signals. That is, in some embodiments, the cell shaping beams are defined by those beams in which reference signals are transmitted by the macro access node 110.

There could be different definitions of the traffic load. In some aspects, the traffic load is defined by spectrum resource utilization. That is, in some embodiments, the current traffic load is defined by spectrum resource utilization in the heterogeneous network 100a, served traffic amount per cell (in terms of total current traffic (in bits per second) per cell or traffic (in bits per second) per unit area.

Further aspects of how the cell shaping beams of the macro access node 110 might be adjusted will be disclosed next.

In some aspects, the cell shaping beams of the macro access node 110 are adjusted so as to reduce the serving region 130 of the macro access node 110 in where the serving region 130 of the macro access node 110 overlaps with the serving region 140 of the micro access node 120. That is, in some embodiments, the cell shaping beams serving the first serving region 130 where the first serving region 130 overlaps with the second serving region 140 are adjusted.

Further aspects of how the cell shaping beams might be adjusted as in step S104 will now be disclosed. In some aspects, the cell shaping beams are adjusted by means of power adjustment. That is, in some embodiments, the cell shaping beams are adjusted by adjusting power of the cell shaping beams. In this respect, power reduction of the cell shaping beams is increased as the traffic load increases. That is, in some embodiments, adjusting the power in step S104 comprises reducing the power of the cell shaping beams from a default power level, and where the higher the current traffic load is, the more the power of the cell shaping beams is reduced.

In some aspects, the cell shaping beams are adjusted by means of reconfigured beamforming weights. That is, in some embodiments, the cell shaping beams are adjusted by adjusting beamforming weights of the cell shaping beams. The cell shapes might thus be adjusted by adjusting the output power, and/or by reconfiguring the beamforming weights. Although not necessarily so, the antenna directivity gain might even be adjusted such that a sub-set of the cell shaping beams will be completely removed, for example by setting the power, or beamforming weights, to some of the cell shaping beams to zero.

Different sets of beamforming weights may be stored in memory and selected as a function of the traffic load, or re-computed so to adjust the serving region 130 of the macro access node 110 as a function of the traffic distribution.

In some aspects, adjusting the cell shaping beams as in step S104 comprises adjusting the number of beams used by the macro access node 110. In particular, in some embodiments, adjusting the cell shaping beams comprises splitting at least one cell shaping beam into two new cell shaping beams. The two new cell shaping beams might have mutually different beam shapes (by not having the same beamforming weights) and/or sizes (by not being fed by the same amount of power).

In some aspects, not all the cell shaping beams of the macro access node 110 are adjusted. Further aspects of which of the cell shaping beams of the macro access node 110 that might be adjusted will be disclosed next.

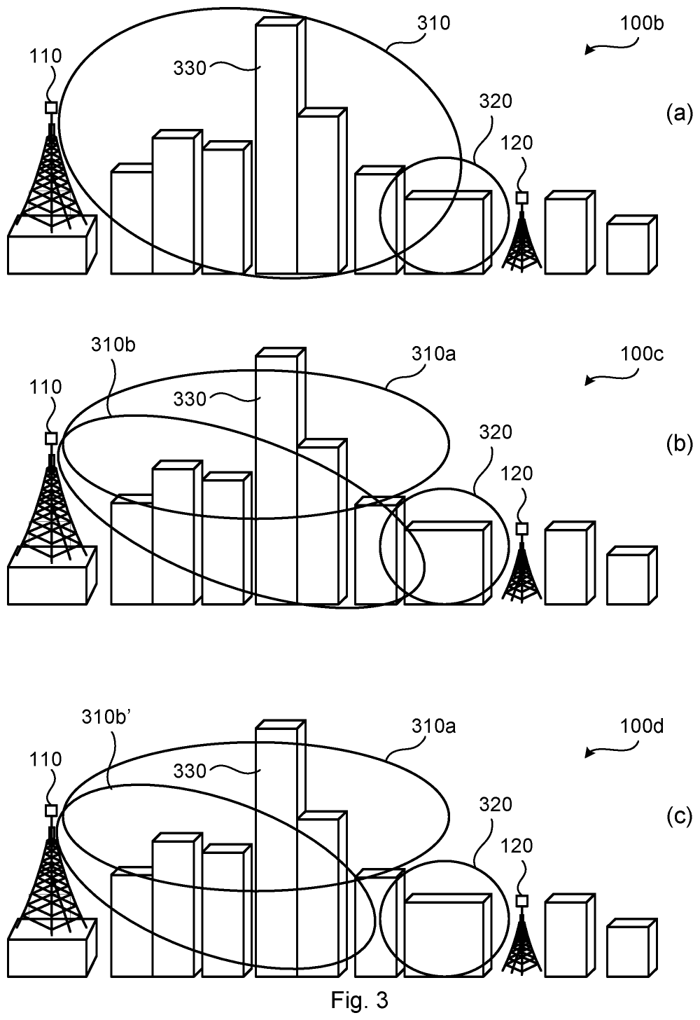

In some aspects, the cell shape is adjusted by adjustment of vertical beams pointing downwards (e.g. towards street level). That is, in some embodiments, at least the cell shaping beams having vertically downwards pointing directions are adjusted. Such an embodiment serves scenarios where micro access nodes 120 are deployed at street level serving users outdoors and on lower floors of buildings. By reducing the coverage of the macro access node 110 at low elevations, users are offloaded to the micro access nodes 120, which means that macro access node 110 can serve users at higher floors of buildings. Such a scenario is illustrated in FIG. 3 which at (a), (b), and (c) illustrates a heterogeneous network 100b, 100c, 100d as in FIG. 1 comprising a macro access node 110 and a micro access node 120 as deployed in an urban environment defined by buildings, one of which is identified at reference numeral 330. In FIG. 3(a) the macro access node 110 communicates in vertical cell shaping beam 310 and micro access node 120 communicates in beam 320. It can be seen that transmission in the cell shaping beam 310 will interfere with transmission (and reception) in beam 320. Therefore, in FIG. 3(b) the cell shaping beam 310 has been adjusted by being split into two cell shaping beams 310a, 310b. Transmission in the cell shaping beam 310b, but not cell shaping beam 310a, will interfere with transmission (and reception) in beam 320. Therefore, in FIG. 3(c) the cell shaping beam 310b has had its antenna directivity gain adjusted, resulting in cell shaping beam 310b′, thereby avoiding interference to beam 320.

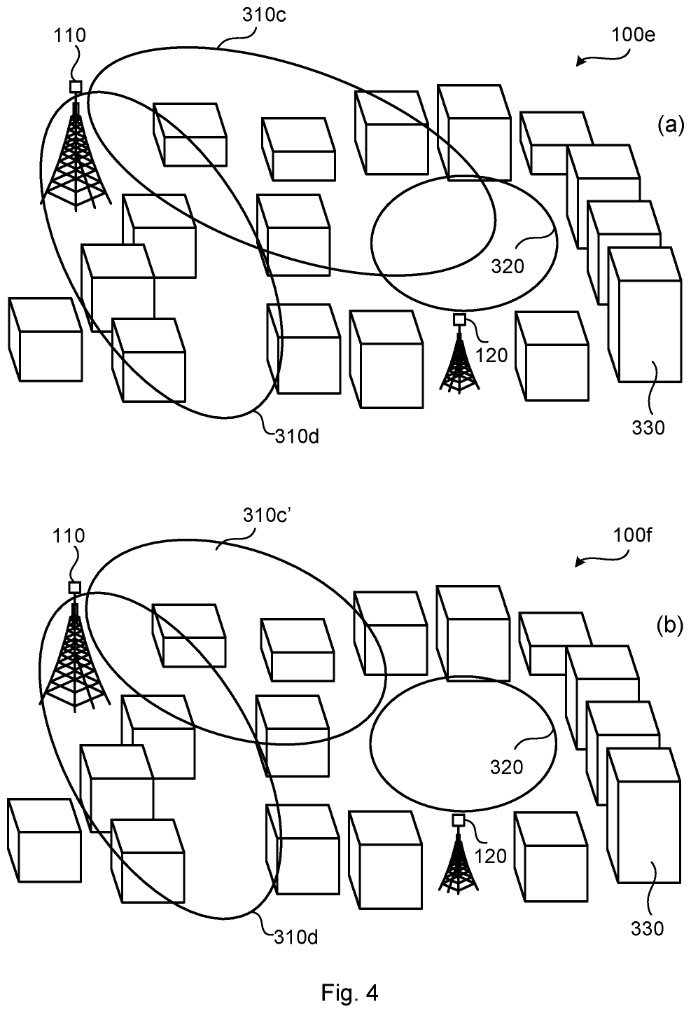

In some aspects, the cell shape is adjusted by adjustment of horizontal beams in a certain beam pointing direction. In particular, in some embodiments, at least a subset of the cell shaping beams having horizontal pointing directions is adjusted. Such an embodiment serves scenarios where micro access nodes 120 are deployed at certain locations, such as a busy town square with comparatively many users (compared to an abandoned factory site with comparatively few users). This allows the micro access nodes 120 to serve users located at the busy town square, whilst the macro access node 110 might use its resources to serve remaining users located elsewhere. Such a scenario is illustrated in FIG. 4 which at (a) and (b) illustrates a heterogeneous network 100e, 100f as in FIG. 1 comprising a macro access node 110 and a micro access node 120 as deployed in an urban environment defined by buildings, one of which is identified at reference numeral 330. In FIG. 4(a) the macro access node 110 communicates in two horizontal cell shaping beams 310c, 310d and micro access node 120 communicates in beam 320. It can be seen that transmission in the cell shaping beam 310c will interfere with transmission (and reception) in beam 320. Therefore, in FIG. 3(b) the cell shaping beam 310c has had its antenna directivity gain adjusted, resulting in cell shaping beam 310c′, thereby avoiding interference to beam 320.

In some embodiments, a combination of those cell shaping beams having vertically downwards pointing directions and a subset of the cell shaping beams having horizontal pointing directions are adjusted. This could be the case in urban scenarios where users have wide distribution in the vertical domain but are concentrated at a few places in the horizontal domain where micro access node 120 could be deployed to increase network capacity.

In some aspects, the traffic load of only the macro access node 110 is considered. That is, in some embodiments, the current traffic load pertains only to the current traffic load of the macro access node 110. In further detail, as the traffic load of the macro access node 110 increases, the macro access node 110 becomes increasingly over-loaded. A fraction of the traffic might therefore be shifted to micro access nodes 120. This can be achieved by the above disclosed adjustment of the cell shaping beams of the macro access node 110. The cell shape of the macro access node 110 might thus be adjusted as a function of the traffic load.

Adjustment of the cell shapes might be activated as the traffic load of the macro access node 110 reaches a certain threshold level. Similarly, adjustment of the cell shapes might be deactivated at low traffic loads. In particular, in some embodiments, the cell shaping beams are adjusted from default beam shapes. Adjustment of the cell shaping beams from the default beam shapes is triggered by the current traffic load of the macro access node 110 being higher than a first threshold value.

At low traffic loads, if high user throughput is to be attained, the preferred configuration could be to serve the users with the best possible link, which in many cases is provided by the macro access node 110. Further in this respect, in order to have achievable throughput at very low traffic load (e.g. yielding high user experience), any activated power back-off at the macro access node 110 could be deactivated at low traffic loads. The cell shaping beams might therefore be adjusted back to the default beam shapes when the current traffic load is lower than a second threshold value. The second threshold value is lower than the first threshold value. Further in this respect, in situations with low traffic loads, the micro access nodes 120 might even be completely switched off for energy efficiency purposes. All users are thereby served by the macro access node 110 as long as the macro access node 110 is capable of provide a sufficiently high quality of service for all its users.

In other aspects, the total traffic load (of the macro access node 110 and the micro access node 120) is considered. That is, in some embodiments, the current traffic load pertains to combined current traffic load of the macro access node 110 and the micro access node 120.

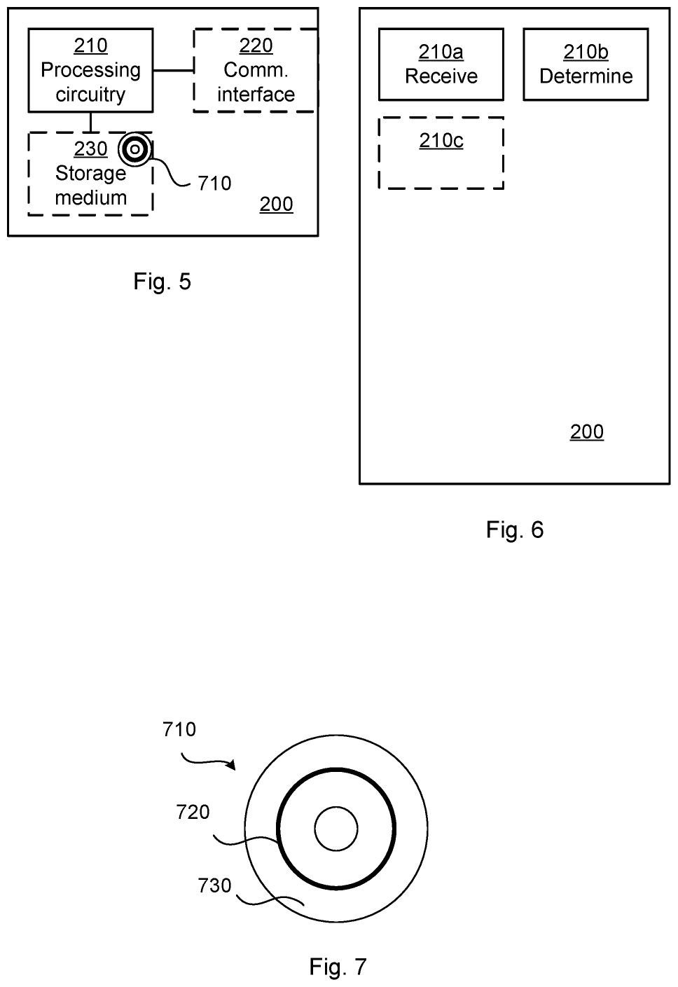

FIG. 5 schematically illustrates, in terms of a number of functional units, the components of a network node controller 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 710 (as in FIG. 7), e.g. in the form of a storage medium 230. The processing circuitry 210 may further be provided as at least one application specific integrated circuit (ASIC), or field programmable gate array (FPGA).

Particularly, the processing circuitry 210 is configured to cause the network node controller 200 to perform a set of operations, or steps, as disclosed above. For example, the storage medium 230 may store the set of operations, and the processing circuitry 210 may be configured to retrieve the set of operations from the storage medium 230 to cause the network node controller 200 to perform the set of operations. The set of operations may be provided as a set of executable instructions.

Thus the processing circuitry 210 is thereby arranged to execute methods as herein disclosed. The storage medium 230 may also comprise persistent storage, which, for example, can be any single one or combination of magnetic memory, optical memory, solid state memory or even remotely mounted memory. The network node controller 200 may further comprise a communications interface 220 at least configured for communications with other entities, functions, nodes, and devices of the heterogeneous network 100. As such the communications interface 220 may comprise one or more transmitters and receivers, comprising analogue and digital components. The processing circuitry 210 controls the general operation of the network node controller 200 e.g. by sending data and control signals to the communications interface 220 and the storage medium 230, by receiving data and reports from the communications interface 220, and by retrieving data and instructions from the storage medium 230. Other components, as well as the related functionality, of the network node controller 200 are omitted in order not to obscure the concepts presented herein.

FIG. 6 schematically illustrates, in terms of a number of functional modules, the components of a network node controller 200 according to an embodiment. The network node controller 200 of FIG. 6 comprises a number of functional modules; an obtain module 210a configured to perform step S102 and a distribute module 210b configured to perform step S104. The network node controller 200 of FIG. 6 may further comprise a number of optional functional modules, as represented by functional module 210c. In general terms, each functional module 210a-210c may in one embodiment be implemented only in hardware and in another embodiment with the help of software, i.e., the latter embodiment having computer program instructions stored on the storage medium 230 which when run on the processing circuitry makes the network node controller 200 perform the corresponding steps mentioned above in conjunction with FIG. 6. It should also be mentioned that even though the modules correspond to parts of a computer program, they do not need to be separate modules therein, but the way in which they are implemented in software is dependent on the programming language used. Preferably, one or more or all functional modules 210a-210c may be implemented by the processing circuitry 210, possibly in cooperation with the communications interface 220 and/or the storage medium 230. The processing circuitry 210 may thus be configured to from the storage medium 230 fetch instructions as provided by a functional module 210a-210c and to execute these instructions, thereby performing any steps as disclosed herein.

The network node controller 200 may be provided as a standalone device or as a part of at least one further device. For example, the network node controller 200 may be provided in a node of the (radio) access network or in a node of the core network 150. In this respect, the network node controller 200 might be part of, integrated with, or collocated with, the macro access node 110. Alternatively, functionality of the network node controller 200 may be distributed between at least two devices, or nodes. These at least two nodes, or devices, may either be part of the same network part (such as the (radio) access network or the core network 150) or may be spread between at least two such network parts. In general terms, instructions that are required to be performed in real time may be performed in a device, or node, operatively closer to the cell than instructions that are not required to be performed in real time.

Thus, a first portion of the instructions performed by the network node controller 200 may be executed in a first device, and a second portion of the of the instructions performed by the network node controller 200 may be executed in a second device; the herein disclosed embodiments are not limited to any particular number of devices on which the instructions performed by the network node controller 200 may be executed. Hence, the methods according to the herein disclosed embodiments are suitable to be performed by a network node controller 200 residing in a cloud computational environment. Therefore, although a single processing circuitry 210 is illustrated in FIG. 5 the processing circuitry 210 may be distributed among a plurality of devices, or nodes. The same applies to the functional modules 210a-210c of FIG. 6 and the computer program 720 of FIG. 7.

FIG. 7 shows one example of a computer program product 710 comprising computer readable storage medium 730. On this computer readable storage medium 730, a computer program 720 can be stored, which computer program 720 can cause the processing circuitry 210 and thereto operatively coupled entities and devices, such as the communications interface 220 and the storage medium 230, to execute methods according to embodiments described herein. The computer program 720 and/or computer program product 710 may thus provide means for performing any steps as herein disclosed.

In the example of FIG. 7, the computer program product 710 is illustrated as an optical disc, such as a CD (compact disc) or a DVD (digital versatile disc) or a Blu-Ray disc. The computer program product 710 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 720 is here schematically shown as a track on the depicted optical disk, the computer program 720 can be stored in any way which is suitable for the computer program product 710.

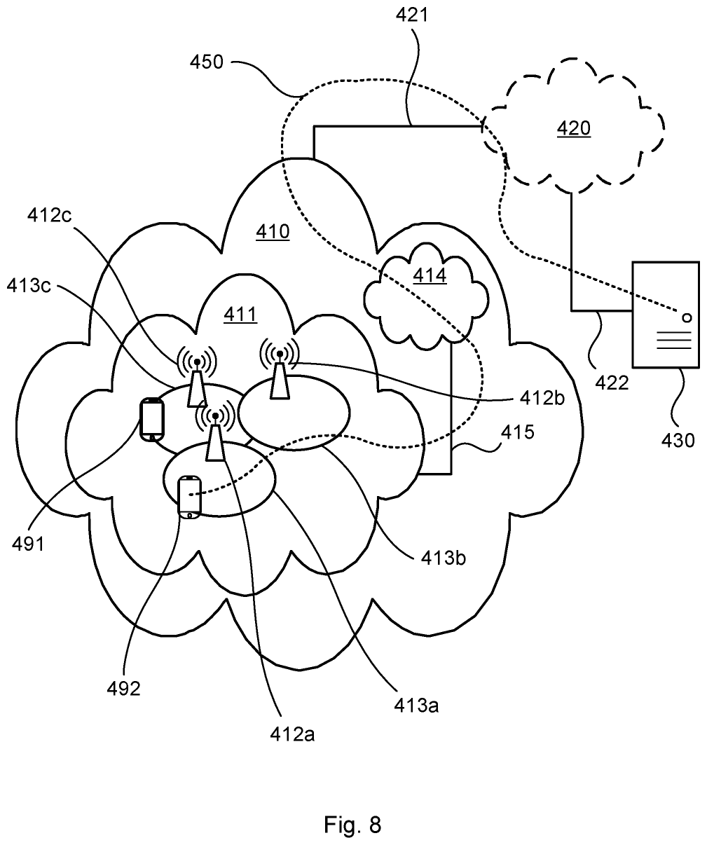

FIG. 8 is a schematic diagram illustrating a telecommunication network connected via an intermediate network 420 to a host computer 430 in accordance with some embodiments. In accordance with an embodiment, a communication system includes telecommunication network 410, such as a 3GPP-type cellular network, which comprises access network 411, such as the (radio) access network in FIG. 1, and core network 414, such as core network 150 in FIG. 1. Access network 411 comprises a plurality of radio access network nodes 412a, 412b, 412c, such as NBs, eNBs, gNBs (corresponding to the access nodes 110, 120 of FIG. 1) or other types of wireless access points, each defining a corresponding coverage area, or cell, 413a, 413b, 413c. Each radio access network nodes 412a, 412b, 412c is connectable to core network 414 over a wired or wireless connection 415. A first UE 491 located in coverage area 413c is configured to wirelessly connect to, or be paged by, the corresponding network node 412c. A second UE 492 in coverage area 413a is wirelessly connectable to the corresponding network node 412a. While a plurality of UE 491, 492 are illustrated in this example, the disclosed embodiments are equally applicable to a situation where a sole UE is in the coverage area or where a sole terminal device is connecting to the corresponding network node 412.

Telecommunication network 410 is itself connected to host computer 430, which may be embodied in the hardware and/or software of a standalone server, a cloud-implemented server, a distributed server or as processing resources in a server farm. Host computer 430 may be under the ownership or control of a service provider, or may be operated by the service provider or on behalf of the service provider. Connections 421 and 422 between telecommunication network 410 and host computer 430 may extend directly from core network 414 to host computer 430 or may go via an optional intermediate network 420. Intermediate network 420 may be one of, or a combination of more than one of, a public, private or hosted network; intermediate network 420, if any, may be a backbone network or the Internet; in particular, intermediate network 420 may comprise two or more sub-networks (not shown).

The communication system of FIG. 8 as a whole enables connectivity between the connected UEs 491, 492 and host computer 430. The connectivity may be described as an over-the-top (OTT) connection 450. Host computer 430 and the connected UEs 491, 492 are configured to communicate data and/or signaling via OTT connection 450, using access network 411, core network 414, any intermediate network 420 and possible further infrastructure (not shown) as intermediaries. OTT connection 450 may be transparent in the sense that the participating communication devices through which OTT connection 450 passes are unaware of routing of uplink and downlink communications. For example, network node 412 may not or need not be informed about the past routing of an incoming downlink communication with data originating from host computer 430 to be forwarded (e.g., handed over) to a connected UE 491. Similarly, network node 412 need not be aware of the future routing of an outgoing uplink communication originating from the UE 491 towards the host computer 430.

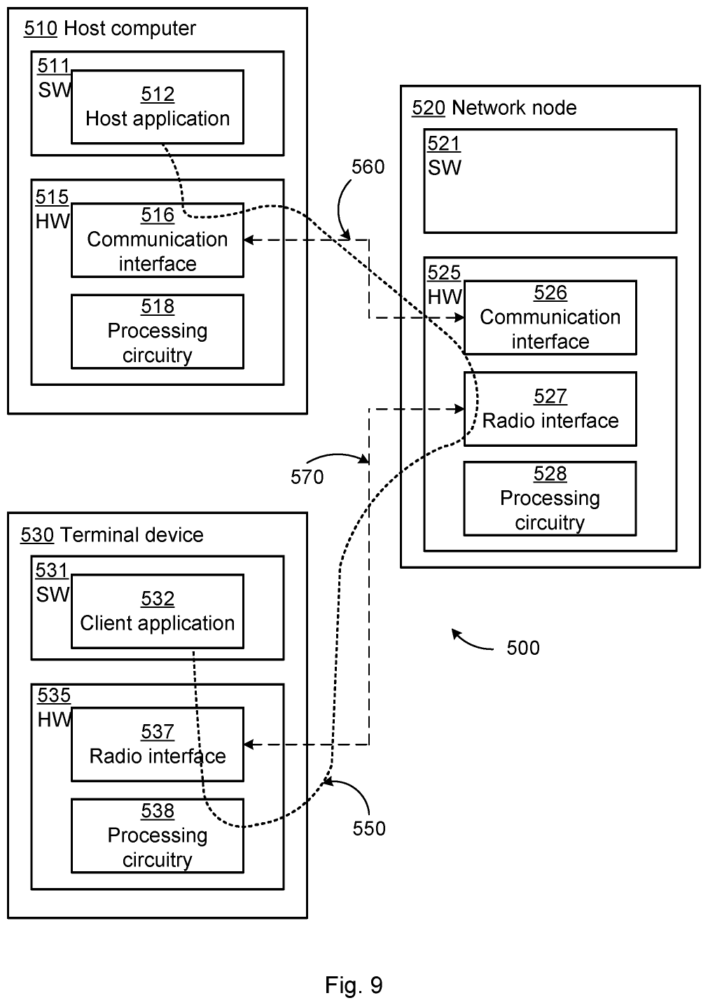

FIG. 9 is a schematic diagram illustrating host computer communicating via a radio access network node with a UE over a partially wireless connection in accordance with some embodiments. Example implementations, in accordance with an embodiment, of the UE, radio access network node and host computer discussed in the preceding paragraphs will now be described with reference to FIG. 9. In communication system 500, host computer 510 comprises hardware 515 including communication interface 516 configured to set up and maintain a wired or wireless connection with an interface of a different communication device of communication system 500. Host computer 510 further comprises processing circuitry 518, which may have storage and/or processing capabilities. In particular, processing circuitry 518 may comprise one or more programmable processors, application-specific integrated circuits, field programmable gate arrays or combinations of these (not shown) adapted to execute instructions. Host computer 510 further comprises software 511, which is stored in or accessible by host computer 510 and executable by processing circuitry 518. Software 511 includes host application 512. Host application 512 may be operable to provide a service to a remote user, such as UE 530 connecting via OTT connection 550 terminating at UE 530 and host computer 510. In providing the service to the remote user, host application 512 may provide user data which is transmitted using OTT connection 550.

Communication system 500 further includes radio access network node 520 provided in a telecommunication system and comprising hardware 525 enabling it to communicate with host computer 510 and with UE 530. The radio access network node 520 corresponds to the access nodes 110, 120 of FIG. 1. Hardware 525 may include communication interface 526 for setting up and maintaining a wired or wireless connection with an interface of a different communication device of communication system 500, as well as radio interface 527 for setting up and maintaining at least wireless connection 570 with UE 530 located in a coverage area (not shown in FIG. 9) served by radio access network node 520. Communication interface 526 may be configured to facilitate connection 560 to host computer 510. Connection 560 may be direct or it may pass through a core network (not shown in FIG. 9) of the telecommunication system and/or through one or more intermediate networks outside the telecommunication system. In the embodiment shown, hardware 525 of radio access network node 520 further includes processing circuitry 528, which may comprise one or more programmable processors, application-specific integrated circuits, field programmable gate arrays or combinations of these (not shown) adapted to execute instructions. Radio access network node 520 further has software 521 stored internally or accessible via an external connection.

Communication system 500 further includes UE 530 already referred to. Its hardware 535 may include radio interface 537 configured to set up and maintain wireless connection 570 with a radio access network node serving a coverage area in which UE 530 is currently located. Hardware 535 of UE 530 further includes processing circuitry 538, which may comprise one or more programmable processors, application-specific integrated circuits, field programmable gate arrays or combinations of these (not shown) adapted to execute instructions. UE 530 further comprises software 531, which is stored in or accessible by UE 530 and executable by processing circuitry 538. Software 531 includes client application 532. Client application 532 may be operable to provide a service to a human or non-human user via UE 530, with the support of host computer 510. In host computer 510, an executing host application 512 may communicate with the executing client application 532 via OTT connection 550 terminating at UE 530 and host computer 510. In providing the service to the user, client application 532 may receive request data from host application 512 and provide user data in response to the request data. OTT connection 550 may transfer both the request data and the user data. Client application 532 may interact with the user to generate the user data that it provides.

It is noted that host computer 510, radio access network node 520 and UE 530 illustrated in FIG. 9 may be similar or identical to host computer 430, one of network nodes 412a, 412b, 412c and one of UEs 491, 492 of FIG. 8, respectively. This is to say, the inner workings of these entities may be as shown in FIG. 9 and independently, the surrounding network topology may be that of FIG. 8.

In FIG. 9, OTT connection 550 has been drawn abstractly to illustrate the communication between host computer 510 and UE 530 via network node 520, without explicit reference to any intermediary devices and the precise routing of messages via these devices. Network infrastructure may determine the routing, which it may be configured to hide from UE 530 or from the service provider operating host computer 510, or both. While OTT connection 550 is active, the network infrastructure may further take decisions by which it dynamically changes the routing (e.g., on the basis of load balancing consideration or reconfiguration of the network).

Wireless connection 570 between UE 530 and radio access network node 520 is in accordance with the teachings of the embodiments described throughout this disclosure. One or more of the various embodiments improve the performance of OTT services provided to UE 530 using OTT connection 550, in which wireless connection 570 forms the last segment. More precisely, the teachings of these embodiments may reduce interference, due to improved classification ability of airborne UEs which can generate significant interference.

A measurement procedure may be provided for the purpose of monitoring data rate, latency and other factors on which the one or more embodiments improve. There may further be an optional network functionality for reconfiguring OTT connection 550 between host computer 510 and UE 530, in response to variations in the measurement results. The measurement procedure and/or the network functionality for reconfiguring OTT connection 550 may be implemented in software 511 and hardware 515 of host computer 510 or in software 531 and hardware 535 of UE 530, or both. In embodiments, sensors (not shown) may be deployed in or in association with communication devices through which OTT connection 550 passes; the sensors may participate in the measurement procedure by supplying values of the monitored quantities exemplified above, or supplying values of other physical quantities from which software 511, 531 may compute or estimate the monitored quantities. The reconfiguring of OTT connection 550 may include message format, retransmission settings, preferred routing etc.; the reconfiguring need not affect network node 520, and it may be unknown or imperceptible to radio access network node 520. Such procedures and functionalities may be known and practiced in the art. In certain embodiments, measurements may involve proprietary UE signaling facilitating host computer's 510 measurements of throughput, propagation times, latency and the like. The measurements may be implemented in that software 511 and 531 causes messages to be transmitted, in particular empty or ‘dummy’ messages, using OTT connection 550 while it monitors propagation times, errors etc.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for distributing traffic between a macro access node and a micro access node in a heterogeneous network, the method being performed by a network node controller, the method comprising:
obtaining information of current traffic load in the heterogeneous network; and
distributing the traffic between the macro access node and the micro access node by adjusting cell shaping beams of the macro access node as a function of the current traffic load.

2. The method according to claim 1, wherein the macro access node is configured to provide service in a first serving region and the micro access node is configured to provide service in a second serving region at least partly overlapping with the first serving region.

3. The method according to claim 2, wherein the cell shaping beams serving the first serving region where the first serving region overlaps with the second serving region are adjusted.

4. The method according to claim 1, wherein the cell shaping beams are adjusted by adjusting power of the cell shaping beams.

5. The method according to claim 4, wherein adjusting the power comprises reducing the power of the cell shaping beams from a default power level, and wherein the higher the current traffic load is, the more the power of the cell shaping beams is reduced.

6. The method according to claim 1, wherein the cell shaping beams are adjusted by adjusting beamforming weights of the cell shaping beams.

7. The method according to claim 1, wherein adjusting the cell shaping beams comprises splitting at least one cell shaping beam into two new cell shaping beams.

8. The method according to claim 7, wherein the two new cell shaping beams have mutually different beam shapes and sizes.

9. The method according to claim 1, wherein at least the cell shaping beams having vertically downwards pointing directions are adjusted.

10. The method according to claim 1, wherein at least a subset of the cell shaping beams having horizontal pointing directions is adjusted.

11. The method according to claim 1, wherein the current traffic load pertains only to the current traffic load of the macro access node.

12. The method according to claim 11, wherein the cell shaping beams are adjusted from default beam shapes, wherein adjustment of the cell shaping beams from the default beam shapes is triggered by the current traffic load of the macro access node being higher than a first threshold value, and wherein the cell shaping beams are adjusted back to the default beam shapes when the current traffic load is lower than a second threshold value lower than the first threshold value.

13. The method according to claim 1, wherein the current traffic load pertains to combined current traffic load of the macro access node and the micro access node.

14. The method according to claim 1, wherein the current traffic load is defined by spectrum resource utilization in the heterogeneous network.

15. The method according to claim 1, wherein the macro access node is configured for operation in a first frequency band and the micro access node is configured for operation in a second frequency band, and wherein the first frequency band and the second frequency band at least partly overlap.

16. The method according to claim 1, wherein the macro access node is configured for operation in a first frequency range and the micro access node is configured for operation in a second frequency range, and wherein the second frequency range is a subrange of the first frequency range.

17. The method according to claim 1, wherein the cell shaping beams are defined by those beams in which reference signals are transmitted by the macro access node.

18. A network node controller for distributing traffic between a macro access node and a micro access node in a heterogeneous network, the network node controller comprising processing circuitry, the processing circuitry being configured to cause the network node controller to:
obtain information of current traffic load in the heterogeneous network; and
distribute the traffic between the macro access node and the micro access node by adjusting cell shaping beams of the macro access node as a function of the current traffic load.

19-20. (canceled)

21. A computer program for distributing traffic between a macro access node and a micro access node in a heterogeneous network, the computer program comprising computer code which, when run on processing circuitry of a network node controller, causes the network node controller to:
obtain information of current traffic load in the heterogeneous network; and
distribute the traffic between the macro access node and the micro access node by adjusting cell shaping beams of the macro access node as a function of the current traffic load.

22. (canceled)
